(19) United States
(12) Patent Application Publication
(10) Pub. No.: US 2022/0226844 A1
(43) Pub. Date: Jul. 21, 2022

(54) PNEUMATIC ROTARY ACTUATED SPRAY GUN

(71) Applicant: TANNER M.J. SCHMITZ, Nebraska City, NE (US)

(72) Inventor: TANNER M.J. SCHMITZ, Nebraska City, NE (US)

(21) Appl. No.: 17/648,293

(22) Filed: Jan. 18, 2022

Related U.S. Application Data
(60) Provisional application No. 63/199,673, filed on Jan. 15, 2021.

(51) Int. Cl. B05B 7/12; B05B 7/10; B05B 7/04

(52) U.S. Cl. CPC B05B 7/12; B05B 7/0483; B05B 7/10

(57) ABSTRACT

The current design as presented contains an adjustable packing nut to tighten the valve chamber into the packing material from the front and effectively sealing the valve chamber into the fluid block allowing you to remove said valve chamber without completely dismantling the fluid block with little to no cleaning involved. Generally, the spray guns available can be bulky cumbersome and uncomfortable in the hand and are hard to clean, the presented design is able to be cleaned easily, dismantled easily, and is constructed with comfort of the end user in mind

### FIELD

The disclosure relates generally to mechanical applications. The disclosure relates specifically to spray guns.

### BACKGROUND

Currently, spray application guns actuate in a linear, reciprocating, or rotational fashion and have a metal chamber with metal face seals pressed against said chamber using retaining caps, springs, and many O-rings on each fluid passageway or a packing material that inefficiently seals the mating faces, leading to unwanted material leakage or premature wear of the chamber, seals, or packings. These assemblies are near impossible to remove a valve chamber, side seal, or packing without completely dismantling and cleaning the fluid block assemblies resulting in unwanted downtime. Generally, the spray guns available can be bulky cumbersome and uncomfortable in the hand and are hard to clean, the presented design is able to be cleaned easily, dismantled easily, and is constructed with comfort of the end user in mind. It would be advantageous to present a design that improves on the shortcomings of the current art.

### SUMMARY

A spray gun comprising: a gun body, a valve rod, a pressure switch, an actuator, a hose coupler block, a fluid block, a nozzle, a rotatable passage valve wherein the actuator is either electrically actuated pneumatically actuated, the nozzle further comprises an optional internal, removeable vortex generating device, and the rotatable passage valve further comprises a cylindrical outlet bore and single or multiple impingement ports parallel or tangential with each other but perpendicular to the outlet bore with multiple positions. The spray gun further comprising a packing material, wherein the packing material is plastic. The vortex creating device creates a multiple mixing action. The singular or plural components are passable or communicated across the passages of the impingement ports prior to optional multiple mixing action.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 Side view of spray gun,

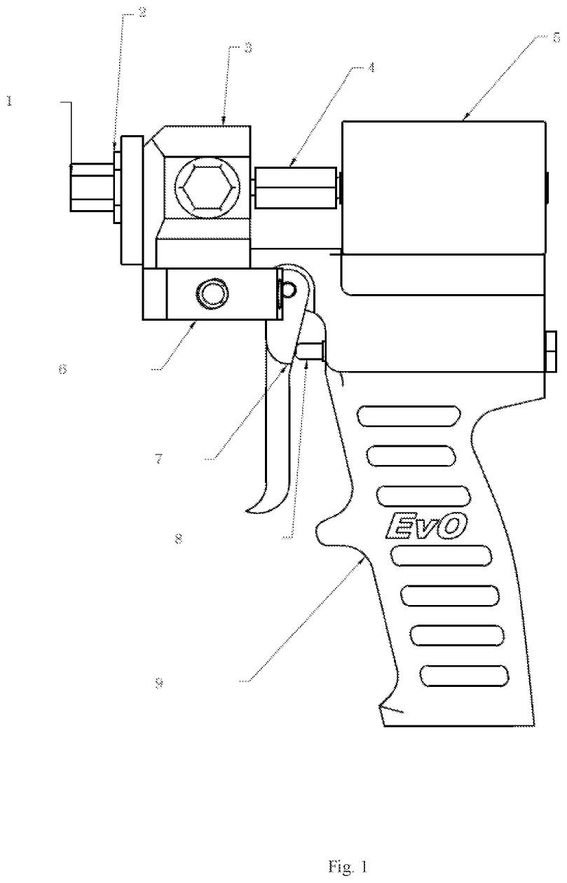

FIG. 2 Above view of spray gun

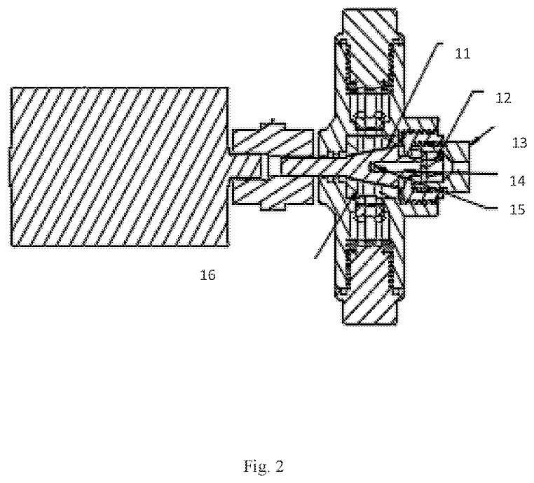

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

A singular or Plural component spray gun dependent upon application with a gas purge, mechanical purge, or fluid purge for spraying singular or plural components is useful in applications including polyurethane foams, elastomeric coatings, paints, thermosetting resin formulations, and the like.

The ejected mixed fluids are atomized under low to high pressure via a multiple mixing action valve and nozzle (1) assembly. The gun design allows for an exchange of valve chambers and nozzles without the need to dismantle the gun or fluid block (3) assembly. The concept of the gun involves a handle (9) with a trigger (7) pressure switch (8) to control the actuator (5) being electric, pneumatic, or mechanical, a hose coupler block (6), a fluid block (3), a packing material, a nozzle (1) consisting of the nozzle (1) and an optional internal but removable vortex generating device (12) wherein the double helical shape of the passage creates a multiple mixing action when required, and a rotatable passage valve (15) with a cylindrical outlet bore (14) and single or multiple impingement ports in parallel or tangential with each other but perpendicular to the outlet bore (14) with multiple positions allowing one position to allow the flow of a gas or liquid purge and multiple adjustable positions at set increments to allow the singular or plural components to pass or mix in said valve chamber with the valve chamber portion positioned totally enclosed in a packing material inside said fluid block (3).

The packing material is formed from many materials, but the specific material is determined when the use and medium are known but are generally a plastic material.

The singular or plural components are passable or communicated across the passages of the impingement ports prior to the optional multiple mixing action started in the chamber and finished in the nozzle (1) which virtually eliminates backflow or unwanted cross contamination of materials.

The valve (15) can be shaped in a conical, spherical, cylindrical, convex, concave, and the like dependent upon design and required configuration.

A gas or fluid purge through the valve chamber is possible through a double or single acting pneumatic cylinder or electric actuator (5) with both electric actuator or pneumatic cylinder and valve reciprocating and rotating through an appropriate connection device. The valve and actuator (5) are connected through an appropriate connection device by which may include but is not limited to form fit shaped holes, screws, keyways, slots.

Possible arrangement options for the spray gun are to have the fluid block (3) assembly connected to a wand extension (not illustrated) to reach a farther distance, a remote spraying apparatus as to remove operator error when electronically controlled in a specific use, a handheld spray gun controlled by the operators hand, or single or multiple spray head configurations for spraying large quantities of material while covering large surfaces either controlled by human operation or machine operation.

The actuating device (5), whether electric or pneumatic, is rotatable from 0-360 degrees via a rotary mechanism and adjustable to control how far the fluid impingement ports are opened, thereby allowing multiple adjustments to be made at any given time by limiting the amount of fluid allowed to pass through the impingement ports at any given time. By using a rotatable assembly over a linear assembly, we are reducing the momentum and force from the weight of the parts from a reciprocating fashion to a rotational fashion, which in turn reduces unwanted wear and vibrations in the assembly and less stress and force on the user or machine as it is actuated. The lightweight and compact design is possible when machined from high strength 70× aluminum and the like or when fiber reinforced 3d printing is used for the gun body, actuator assembly, or the fluid block assembly.

The current design as presented contains an adjustable packing nut (2) to tighten the valve chamber (4) into the packing material from the front and effectively sealing the valve chamber (4) into the fluid block (3) allowing a user to remove said valve chamber (4) without completely dismantling the fluid block (3).

This design is improved over prior designs in several ways. Prior designs have matching nozzles and valve chambers allowing for only a set and specific combination of components. The presented design presented allows any combination of the valve chambers and nozzles which allows for a near endless possibility of combinations, especially when combined with the ability to adjust the rotational stroke of the electric or pneumatic actuator limiting the flow into the valve chamber (4) via the impingement ports as previously mentioned above.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A singular or plural component spray gun comprising: a handle, connected to a trigger, a pressure switch connected to the trigger, an actuator connected to a hose coupler block connected to a fluid block connected to a packing nut connected to a nozzle, a spray medium supply device, and a rotatable passage valve wherein:
the actuator is may be mechanical, electric, pneumatic;
the nozzle further comprises an optional internal, removeable vortex generating device;
and wherein the rotatable passage valve further comprises a cylindrical outlet bore and single or multiple impingement ports parallel or tangential with each other but perpendicular to the outlet bore with multiple positions.

2. The spray gun of claim 1 further comprising a packing material.

3. The spray gun of claim 2 wherein the packing material is plastic.

4. The spray gun of claim 1 wherein the vortex creating device creates a multiple mixing action.

5. The spray gun of claim 1 wherein the singular or plural components are passable or communicated across the passages of the impingement ports prior to optional multiple mixing action.

6. The spray gun of claim 1 comprising a rotational limiting device.

7. The device of claim 6 wherein the device controls spray rotationally in increments via the impingement ports allowing for adjustments in spray medium flow capacity.

8. The spray gun of claim 1 wherein the hose coupling block quickly mates to the fluid block and is directly connected to the spray medium supplying device.

9. The spray gun of claim 1 further comprising a a packing nut, wherein the packing nut tightens the packing on the valve chamber to create a leak free seal.

10. The spray gun of claim 1 further comprising washers, springs, and seals.

11. The spray gun of claim 1 wherein the hose coupler block possess multiple mounting locations for hoses available and multiple inlet positions possessing multiple corresponding, directly aligned, outlet positions on the fluid block.

12. The spray gun of claim 1 further comprising a handle or mounting body for machine operation.

13. The spray gun of claim 1 further comprising a set of porting or mechanical hardware for purge method and actuation of the actuator.
